(19) United States
(12) Patent Application Publication
(10) Pub. No.: US 2007/0018526 A1
(43) Pub. Date: Jan. 25, 2007

(54) Relay for sealed ac load and ag-base contact element material for use therein

(75) Inventors: Nobuhito Yanaginara, Hiratsuka-shi (JP); Osamu Sakaguchi, Hiratsuka-shi (JP); Toshiya Yamamoto, Hiratsuka-shi (JP)

Correspondence Address: ROTHWELL, FIGG, ERNST & MANBECK, P.C., 1425 K STREET, N.W., SUITE 800, WASHINGTON, DC, 20005, US

(73) Assignee: TANAKA KIKINZOKU KOGYO K.K., Tokyo (JP)

(21) Appl. No.: 10/567,784

(22) PCT Filed: Jun. 17, 2005
(86) PCT No.: PCT/JP05/11116

§ 371 Date: Feb. 9, 2006

(30) Foreign Application Priority Data
Jun. 18, 2004 (JP) 2004-181554

(51) Int. Cl. H02K 21/00

(52) U.S. Cl. 310/207

(57) ABSTRACT

A sealed relay for alternating current load is provided which has attained an excellent endurance against a resistance load comprising an alternating voltage of 80 V to 300 V and a rated current of 5 to 25 A, and particularly, a sealed relay for alternating current load is provided which has a very excellent endurance even under a high temperature atmosphere. The present invention provides a sealed relay for alternating current load, which controls a resistance load comprising an alternating voltage of 80 V to 300 V and a rated current of 5 to 25 A by an Ag-based contact element disposed in the closed space thereof, wherein the Ag-based contact element comprises 4.0 to 20.0 wt. % of an iron oxide, optionally 0.1 to 2.5 wt. % of oxides of one or more selected from the group consisting of magnesium, aluminum, indium, lanthanum, cerium and samarium, and Ag as the balance.

### TECHNICAL FIELD

The present invention relates to a sealed relay for controlling alternating current load, and particularly to a sealed relay for alternating current load which has attained a remarkable endurance against a resistance load comprising an alternating voltage of 80 V to 300 V and a rated current of 5 to 25 A under a high temperature atmosphere.

### BACKGROUND ART

Electric contact elements capable of opening or closing electric circuits are generally called electric contacts. The electric contacts are required to have the characteristic of transmitting electric currents or signals passing therethrough by metal-to-metal contact and also the characteristic of blocking them without trouble by separating the metals. Such electric contacts are structurally simple, but are known to cause a variety of physical and/or chemical phenomena on their surfaces. Examples of the phenomena include adsorption, oxidation, sulfurization, synthesis of organic compounds, as well as fusion, evaporation, contact erosion, transfer and the like which are associated with electric discharge. These phenomena form a very complex combination of phenomena, which remains a lot to be understood scientifically. If the phenomena occur, the contact function of the electric contacts is inhibited or may stop (due to, e.g., welding), thereby limiting the performance or life of electric products and the like having the electric contacts incorporated. This indicates that electric contacts are one of the key components that determines the life or performance of electric products and the like.

Relays, a representative example of electric products comprising such electric contacts, are widely used ranging from light electric appliances, such as telephones and telegraphs and various electronic devices, to heavy electric equipment, such as that for blocking a large current. Accordingly, very different functions are required of individual relays, and electric contacts having characteristics appropriate to individual purposes of use and relays employing the electric contacts have been developed and marketed as very numerous types of products.

The relays comprising electric contacts refer to electricity relaying devices, each of which forms a coil magnetic flux induced by electric signals applied thereto in the form of direct, alternating or impulse current, and attracts a movable piece of iron by the magnetic force to open or close the electric contact depending on the motion of the movable piece of iron. More common relays for alternating current load, among them, are built in home electric appliances, air conditioners, audio instruments, communication devices, etc. and are required to ensure stable on/off operations under many different conditions of load and environment. In recent years, as home electric appliances, air conditioners, audio instruments, communication devices, etc. have advanced toward higher functions, higher performances and lower power consumption, their components have been miniaturized rapidly, including relays built in those products. Miniaturization of relays necessitates further scaledown of their electric contacts, resulting in much smaller contact forces of the contacts and thus a much higher aggressiveness of the environment to which the contact material is exposed, making maintenance of the contact characteristics very hard.

Relays for alternating current load are mounted very often on print circuit boards (PCB) for typical applications. These relays, called PCB relays, are generally immersion-cleaned to remove the soldering flux after they have been mounted thereon. In order to keep the washing solution from penetrating into the relays at that time, they are very often sealed relays which are enclosed by plastic cases and entirely sealed with a sealant or the like.

Electric contact materials built in the sealed relays have long been known to be represented by Ag—CdO contact materials. The Ag—CdO contact materials have resistances to both welding and contact erosion and stability of contact resistance which are essential to electric contact materials and satisfactorily well-balanced at a high level. However, Cd, among such electric contact materials, is an element toxic to a human body and its production and use are not preferable in view of current environmental problems and others. Additionally, the use of Cd-based materials in relays for alternating current load, which are relevant to the present invention, is scheduled to be banned in Europe in July, 2006. It will be therefore necessary to develop electric contact materials free of Cd for the relays for alternating current load. The conventional Cd-free technology includes the following:

Electric contact materials such as Ag—SnO₂ (alloys composed of 5-15 wt. % of SnO₂ and the remaining Ag), Ag—SnO₂—In₂O₃ and Ag—ZnO types have long been known which are used in relays for alternating current load and others (Patent Documents 1 and 2). Since the oxides are highly thermostable, these Ag-Oxide contact materials are widely used as Cd-free electric contact materials in relays for alternating current load under loading conditions where large rush currents are generated.

Patent Document 1: Japanese Patent Publication No. Sho 55-4825; official gazette

Patent Document 2: WO 00/65623; pamphlet

However, the Cd-free electric contact materials so far proposed may be as endurable as Ag—CdO contact materials for unsealed relays, but are known to exhibit a significantly decreased endurance life for sealed relays. This tendency is more evident especially in a high-temperature atmosphere. More specifically, when the environment where electronic devices or electric appliances comprising relays are used or when heat generation of the relays themselves forces the electric contact materials to be exposed to a high-temperature atmosphere, the relays are likely to exhibit a shorter endurance life than otherwise. In contrast, the Ag—CdO contact materials are known not to exhibit a decreased endurance life even when they are used in sealed relays, as opposed to the Cd-free electric contact materials described above, wherein the Ag—CdO contact materials have resistances to both welding and contact erosion and stability of contact resistance which are satisfactorily well-balanced at a high level.

### DISCLOSURE OF THE INVENTION

### Problems to be Solved by the Invention

As described above, it is mostly uncertain why sealed relays for alternating current load exhibit a decreased endurance life and no definitive measure against the phenomena has not been presented. Thus, such a measure must be taken occasionally, for example, for PCB relays, as the tops of the sealed relays are holed intentionally after the printed boards are washed to change the relays into unsealed relays. When it is difficult to hole the tops of PCB relays in a line for mounting the relays on printed boards, they are used as sealed relays as they are, but it must be then noticed that they may have the number of switching cycles far below the guaranteed number of cycles.

Furthermore, when electronic devices or electric appliances are installed outdoors, the relays are often prevented from operating stably because dusts, insects, etc. entering the equipment intrude inside through the opened holes of the relays and attach themselves to the surface of the contacts, or a corrosive gas enters into the relays, so that the surface of the contacts are fouled or corroded. When unsealed relays for alternating current load having a large opening are used, it is inevitable at present to cause a high frequency of problems of the above-described fouling and corrosion.

### MEANS FOR SOLVING THE PROBLEMS

The present inventors have invented a sealed relay for alternating current load according to the present invention as a result of extensive investigations to solve the above mentioned problems. The present invention is characterized in that an Ag-based contact element comprising 4.0 to 20.0 wt. % of an iron oxide and Ag as the balance is used in a sealed relay for alternating current load, wherein the Ag-based contact element disposed in its closed space controls a resistance load comprising an alternating voltage of 80 V to 300 V and a rated current of 5 to 25 A.

The sealed relay for alternating current load according to the present invention comprises an Ag-based contact element in its closed space to improve its endurance life, wherein the Ag-based contact element contains a predetermined amount of an iron oxide, an oxide of iron which is a metal having a melting temperature higher than Ag and makes no solid solution with Ag. The sealed relay for alternating current load according to the present invention has been proved to have excellent relay properties such as contact reliability and endurance even when it is made in a smaller size. Further, the sealed relay for alternating current load according to the present invention has been found to show a pronounced improvement of endurance life especially in a high-temperature atmosphere.

The study of the present inventors has revealed that the endurance life of a relay for alternating current load may critically depend on phenomena occurring on its contact surface. Unsealed relays for alternating current load generally produce arc just as the contacts are opened during switching operations and the arc fuses the contact surface. As for unsealed relays of an Ag-Oxide material, when the arc fuses the contact surface, Ag and the oxide separate from each other at a part of the surface and the uppermost portion of the contact surface is transformed into a structure with the oxide more coarsened than in its initial state. However, the oxide is still dispersed in the Ag matrix even when such coarsening of the oxide takes place, which can prevent welding troubles unless the contact erosion of the contact material causes a significant reduction of the contact force. A sealed relay for alternating current load has been observed to exhibit no or little of the oxide on the uppermost portion of the contact surface after switching operations, wherein the contact is made of an Ag-Oxide material. Welding troubles are very easily caused at an early stage in the switching operations.

The present inventors, paying attention to the above phenomena, have supposed that a difference in endurance life between the open and sealed relays will be due to a difference in degenerative phenomena on the contact surface between them. It is supposed that in the unsealed relays, arc heat associated with switching may readily decompose the oxide on the contact surface and then reoxidize the decomposition products to form a redox cycle phenomenon which may be repeated on the contact surface.

On the other hand, it is supposed that in the sealed relays, a resin, i.e., a packaging material used to close the electric contact, may emit an organic gas, which may be then decomposed oxidatively in the closed space of the relay by arc heat, resulting in consumption of oxygen sealed inside of the relay. Therefore, it is supposed that in the sealed relays, the oxide on the contact surface may be decomposed but not subjected to the redox cycle phenomenon which may not occur as in the unsealed relays, since oxygen consumption by oxidative decomposition of the organic gas may decrease the partial pressure of oxygen to a great extent in the sealed relays.

Thus, in the sealed relays, the oxide on the contact surface may be kept in a reduced form, and if the metal element composing the oxide is such an element as can easily form a solid solution with Ag, the melting temperature of the material on the contact surface will be lowered so greatly as to induce welding troubles early in switching operations. Conventional contact materials of Ag—SnO₂ and Ag—SnO₂—In₂O₃ types are quite typical of this phenomenon and considered to have limited their endurance life as sealed relay for alternating current load.

Based on the above study of the present inventors, in the sealed relay according to the present invention for alternating current load which comprises an Ag-based contact material containing a predetermined amount of the iron oxide in its closed space, the melting temperature of the material on the contact surface is not lowered even when the iron oxide is present in a reduced form since the iron as metal has a higher melting temperature than Ag and makes no solid solution with Ag. As a consequence, the sealed relay does not encounter welding troubles which have occurred in the conventional counterparts and is able to present a significantly longer endurance life.

Further, the present inventors have found that the sealed relay for alternating current load according to the present invention shows a great improvement of endurance life especially in a high-temperature atmosphere. The sealed relay for alternating current load according to the present invention can provide a practical endurance life at an atmospheric temperature ranging from 50° C. to 150° C. which has not been attained by the conventional contact materials. According to the study of the present inventors, it was verified that a sealed relay for alternating current load comprising a conventional contact material, for example, of Ag 88%-SnO₂ 12% tended to fail at 100,000 cycles or less at an atmospheric temperature above 50° C., which was below the practical level of endurance life, but the inventive sealed relay for alternating current load had an endurance life about eight times as long as a counterpart comprising any of the conventional contact materials even at an atmospheric temperature ranging from 50° C. to 150° C.

The sealed relay for alternating current load according to the present invention comprises an Ag-based contact material preferably containing 4.0 to 20.0 wt. % of the iron oxide. If it is below 4.0 wt. %, the contact material tends to be difficult to keep the practical level of welding resistance at a resistance load capable of producing an incoming current for the contact material, and if it is above 20.0 wt. %, the contact material is not processable satisfactorily. The study of the present inventors has shown that the optimum content of the iron oxide ranges from 6.0 to 16.0 wt. %.

A further study by the present inventors has revealed that the material of the Ag-based contact element used in the inventive sealed relay for alternating current load effectively contains 4.0 to 20.0 wt. % of the iron oxide, 0.1 to 2.5 wt. % of oxides of one or more selected from the group consisting of magnesium, aluminum, indium, lanthanum, cerium and samarium, and Ag as the balance. The material of the inventive Ag-based contact element comprises oxides as additive which have a low standard free energy of oxide formation and are resistant to reduction even in an atmosphere with a low partial pressure of oxygen, that is, oxides of one or more selected from the group consisting of magnesium, aluminum, indium, lanthanum, cerium and samarium in order to further improve the endurance life of the sealed relay for alternating current load. If the content of the oxides is below 0.1 wt. %, the contact material tends to be difficult to further improve the endurance life, and if it is above 2.5 wt. %, the contact material is not processable satisfactorily. The study of the present inventors has shown that the optimum content of the oxides ranges from 0.5 to 2.0 wt. %.

### EFFECT OF THE INVENTION

The present invention can produce a sealed relay for alternating current load which has attained a remarkable endurance against a resistance load comprising an alternating voltage of 80 V to 300 V and a rated current of 5 to 25 A, and a sealed relay for alternating current load very suitable particularly for a high temperature atmosphere.

### BRIEF DESCRIPTION OF THE DRAWINGS

FIG. 1 is a graph showing endurance test results of unsealed relays under the conditions 1;

FIG. 2 is a graph showing endurance test results of unsealed relays under the conditions 2;

FIG. 3 is a graph showing endurance test results of sealed relays under the conditions 3; and

FIG. 4 is a graph showing endurance test results of sealed relays under the conditions 4.

### BEST MODE FOR CARRYING OUT THE INVENTION

Preferable embodiments of the present invention will be described based on First Embodiment and Second Embodiment shown below. First Embodiment: Table 1 shows the compositions of Ag-based contact materials containing the iron oxide (Fe₂O₃) used in relays for alternating current load in Examples 1 to 4 which are included in First Embodiment. Conventional Examples 1 to 3 in Table 1 show conventional Ag-based contact materials, in which have been typically employed in relays for alternating current load. Comparative Example 1 shows a Ag—CdO contact.

TABLE 1

| | Composition (wt %) |
|---|---|
| Example 1 | Ag92.0-Iron Oxide 8.0 |
| Example 2 | Ag90.0-Iron Oxide 10.0 |
| Example 3 | Ag88.0-Iron Oxide 12.0 |
| Example 4 | Ag86.0-Iron Oxide 14.0 |
| Conventional Example 1 | Ag88.3-SnO₂11.7 |
| Conventional Example 2 | Ag88.0-SnO₂7.8-In₂O₃4.0-NiO0.2 |
| Conventional Example 3 | Ag91.0-ZnO9.0 |
| Comparative Example 1 | Ag88.0-CdO12.0 |

Electric contact materials of Examples 1 to 4 were produced via powder metallurgy. First, an Ag powder having an average particle size of 3 μm and an iron oxide powder having an average particle size of 2 μm were weighed as raw powders at a predetermined mixing ratio, and mixed in a V-shaped mixer to form a mixed powder. Then, this mixed powder was pressed to produce a cylindrical billet with a 50 mm φ. On the other hand, electric contact materials of Conventional Examples 1 to 3 and Comparative Example 1 were produced in a typical high frequency melting furnace. Ag alloys having different compositions were melted and molded into ingots, which were then subjected to hot extrusion to obtain wire rods 6 mm in diameter. Subsequently, the wire rods were drawn to a diameter of 2 mm while they were annealed at 700° C., and cut at 2-mm lengths to produce chips with 2-mm diameter by 2-mm length. The chips were oxidized internally under 5 atm. of oxygen at a temperature of 750° C. for 48 hours, the oxidized chips were collected and pressed to produce a cylindrical billet with a 50-mm diameter.

Each cylindrical billet obtained as described above was contained in a cylindrical vessel and pressed in the longitudinal direction of the cylindrical billet for its compression forming. In the compression forming, the cylindrical billet could be deformed in the longitudinal direction thereof, but not in the lateral direction thereof perpendicular to the longitudinal direction since the side of the cylindrical billet was confined by the cylindrical vessel. The compression forming was followed by sintering the billet at 850° C. for 6 hours. The compression forming and the sintering were repeated four times, respectively.

The compression-formed and sintered billet was subjected to hot extrusion to form wire rods 7 mm in diameter (the extrusion area ratio of about 51:1). Then, the wire rods were drawn to a diameter of 2.3 mm and processed by a header machine to produce rivet contacts having a head diameter of 3.2 mm and a head height of 1 mm.

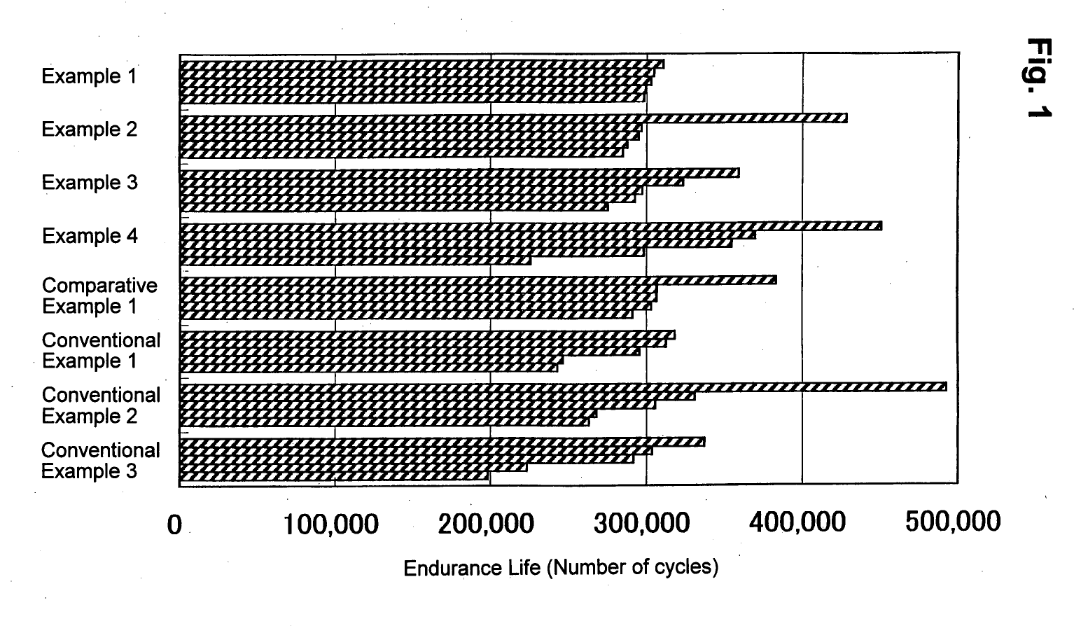

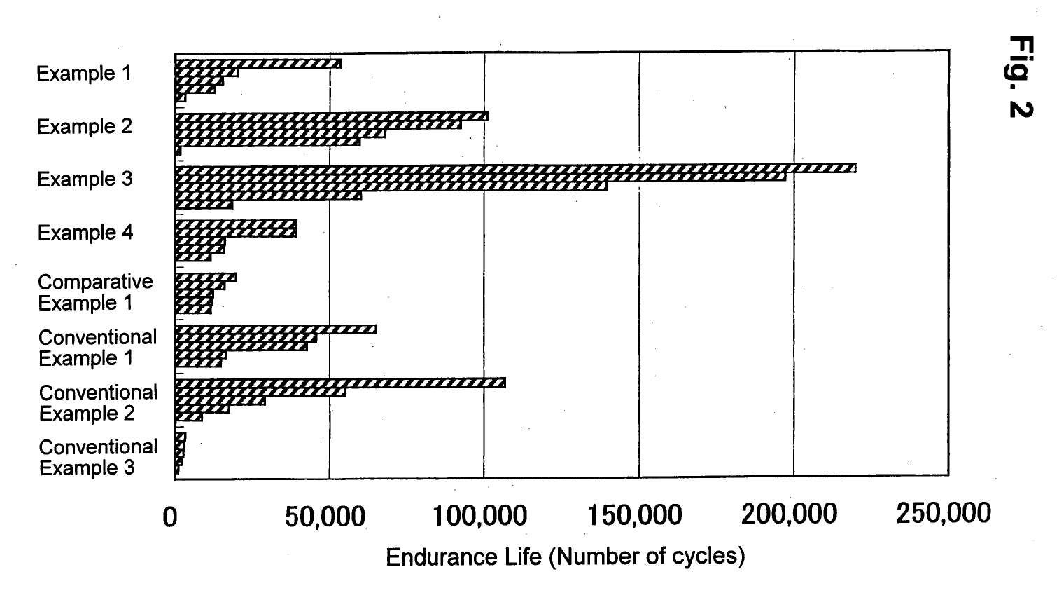

Test for unsealed relays: Each rivet contact obtained as described above was built in a unsealed relay for alternating current load to carry out an endurance test for unsealed relays. The endurance test was conducted under two different conditions for endurance test shown in Tables 2 and 3. Five or more relays were used for each type of contact material to make switching operations and count the number of switching cycles attained by the time they failed. The results of the endurance test are shown in FIG. 1 (the results under the conditions shown in Table 2) and FIG. 2 (the results under the conditions shown in Table 3).

TABLE 2
Conditions 1 for Endurance Test for Unsealed relays

| | |
|---|---|
| Voltage | AC250 V |
| Rated Current | 10 A |
| Load Power | Resistance |
| Switching Frequency | ON for 1.0 sec./OFF for 1.0 sec. |
| Temperature of Testing Atmosphere | 20° C. |
| Relay | Open |

TABLE 3

| | |
|---|---|
| Voltage | AC125 V |
| Rated Current | 78 A |
| Load Power | Lamp |
| Switching Frequency | ON for 5.0 sec./OFF for 5.0 sec. |
| Temperature of Testing Atmosphere | 20° C. |
| Relay | Open |

The results shown in FIGS. 1 and 2 have revealed that in the endurance test for unsealed relays under the conditions shown in Tables 2 and 3, the Ag—CdO type material of Comparative Example 1 (the number of switching cycles averaged over 5 relays: about 318,000 under conditions 1; and about 14,000 under conditions 2—all the numbers of switching cycles described below are also averaged over 5 relays—), the Ag—SnO₂ type material of Conventional Example 1 (about 283,000 under conditions 1; and about 37,000 under conditions 2), the Ag—SnO₂—In₂O₃ type material of Conventional Example 2 (about 332,000 under conditions 1; and about 43,000 under conditions 2) and the Ag—ZnO type material of Conventional Example 3 (about 271,000 under conditions 1; and about 2,000 under conditions 2) are practically satisfactory as contact material. Compared with the conventional materials of these examples, the Ag-Oxide materials of the present examples have been found to have similar or better endurances. The relays of Example 1 attained about 303,000 cycles under conditions 1 and about 21,000 cycles under conditions 2, those of Example 2 about 314,000 under conditions 1 and about 65,000 under conditions 2, those of Example 3 about 310,000 under conditions 1 and about 127,000 under conditions 2, and those of Example 4 about 340,000 under conditions 1 and about 24,000 under conditions 2.

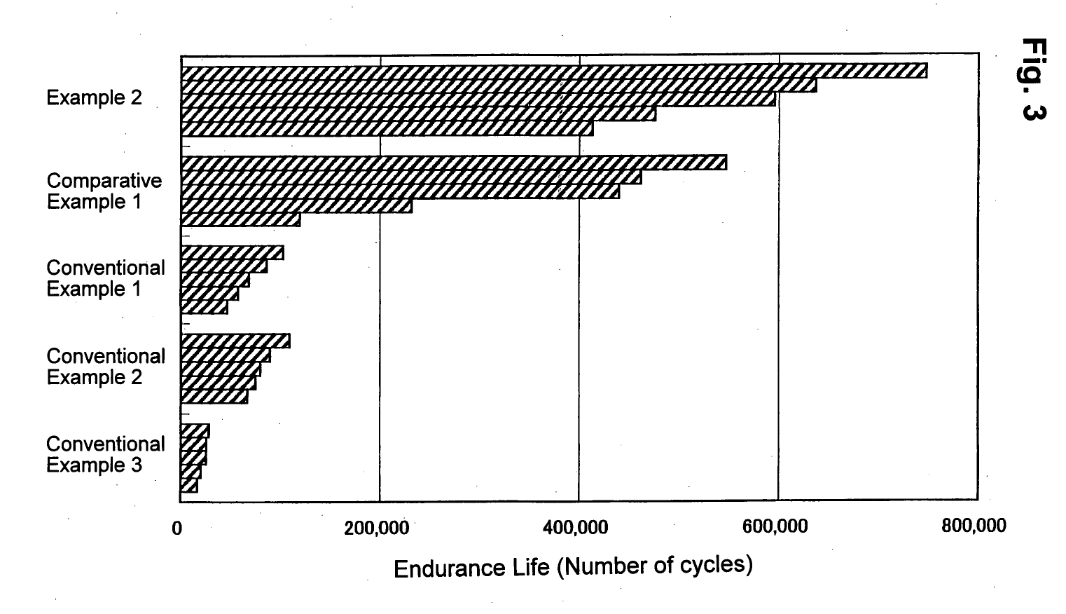

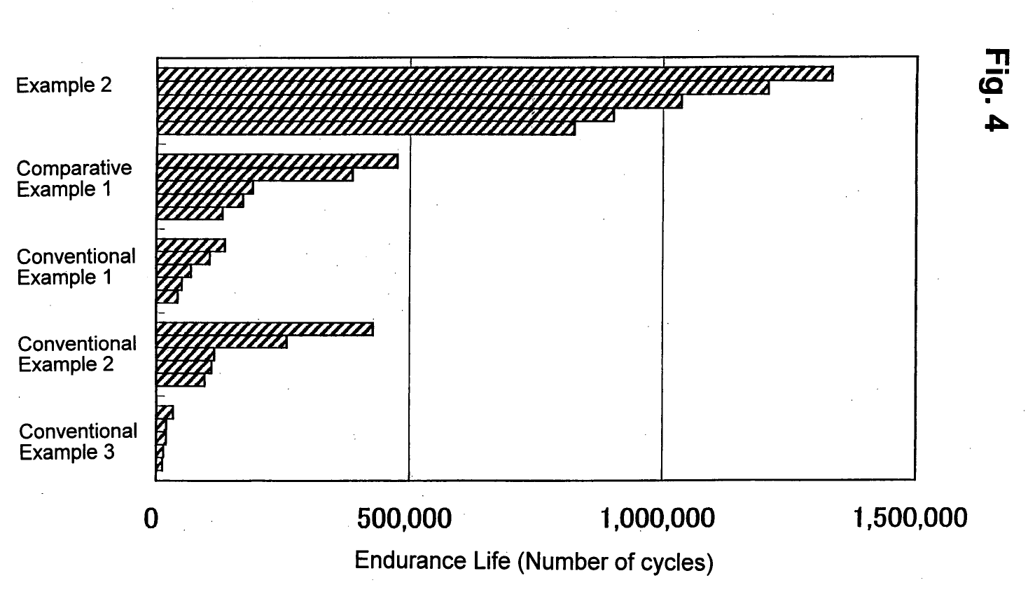

Test for sealed relays: Rivet contacts derived from the respective contact materials in Example 2, Conventional Examples 1 to 3 and Comparative Example 1 were chosen from among the rivet contacts obtained as described above, and built in sealed relays for alternating current load to carry out the second endurance test for sealed relays. The endurance test was conducted under two different conditions for endurance test shown in Tables 4 and 5. Five or more relays were used for each type of contact material to make switching operations and count the number of switching cycles attained until they failed. The results of the endurance test are shown in FIG. 3 (the results under the conditions shown in Table 4) and FIG. 4 (the results under the conditions shown in Table 5). The sealed relays used in this endurance test were obtained by sealing the above unsealed relays with a thermosetting resin, and thus there is no difference in structure, assembling conditions or else between the relays themselves of both types.

TABLE 4
Conditions 3 for Endurance Test for Sealed relays

| | |
|---|---|
| Voltage | AC250 V |
| Rated Current | 10 A |
| Load Power | Resistance |
| Switching Frequency | ON for 1.0 sec./OFF for 1.0 sec. |
| Temperature of Testing Atmosphere | 20° C. |
| Relay | Closed |

TABLE 5
Conditions 4 for Endurance Test for Sealed relays

| | |
|---|---|
| Voltage | AC250 V |
| Rated Current | 10 A |
| Load Power | Resistance |
| Switching Frequency | ON for 1.0 sec./OFF for 1.0 sec. |
| Temperature of Testing Atmosphere | 85° C. |
| Relay | Closed |

The following facts have been found out from the results shown in FIG. 3, which were obtained from the endurance test under the conditions shown in Table 4. The endurance test conditions in Table 1 or 4 is different from the other only in the relay type, open or closed, but is identical to the other in the remaining conditions. However, it has been clearly noticed that the contact materials of Conventional Examples 1 to 3 had lower endurances in the sealed relays than in the unsealed relays. Specifically, the contact material of Conventional Example 1 provided about 283,000 cycles for the unsealed relays under conditions 1, but about 73,000 cycles for the sealed relays under conditions 3; the contact material of Conventional Example 2 provided about 332,000 cycles for the unsealed relays under conditions 1, but about 84,000 cycles for the sealed relays under conditions 3; and the contact material of Conventional Example 3 provided about 271,000 cycles for the unsealed relays under conditions 1, but about 23,000 cycles for the sealed relays under conditions 3. In contrast, the contact material of Comparative Example 1 provided about 340,000 cycles for the unsealed relays under conditions 1, and about 360,000 cycles for the sealed relays under conditions 3, which is different from the results provided by the contact materials of Conventional Examples. However, what happened in this way is still difficult to reason definitely since the mechanism of endurance has not been clarified fully.

Differently from the results provided by the known contact materials as described above, it has been demonstrated that the Ag-Oxide contact material of Example 2 has a higher endurance in the sealed relays than in the unsealed relays. Specifically, the contact material of Example 2 provided about 318,000 cycles for the unsealed relays under conditions 1, and about 574,000 cycles for the sealed relays under conditions 3.

Further, the results of the endurance test in a high-temperature atmosphere shown in Table 5 have revealed that the sealed relays comprising the electric contacts of Conventional Examples 1 to 3 have significantly decreased endurances. Specifically, the sealed relays in such a high-temperature atmosphere provided about 271,000 cycles in Conventional Example 1, and about 81,000 cycles in Conventional Example 1, about 201,000 cycles in Conventional Example 2, and about 20,000 cycles in Conventional Example 3. On the contrary, the Ag-Oxide type of electric contact material of Example 2 has been found to have a very high endurance life property which is practically acceptable in the high-temperature atmosphere with the severity of 85° C. Specifically, the sealed relays of Example 2 provided about 1,060,000 average switching cycles. This result indicates a remarkable improvement of endurance life, even if it is compared with the results that the contact material of Comparative Example 1 provided about 340,000 cycles for the unsealed relays under conditions 1, and about 360,000 cycles for the sealed relays under conditions 3.

Second Embodiment: Table 6 shows the compositions of Ag-based contact materials containing the iron oxide as well as an oxide of magnesium or the like which were used in relays for alternating current load in Examples 5 to 14 which are included in Second Embodiment.

TABLE 6

| | Composition (Wt %) |
|---|---|
| Example 5 | Ag90.0-Fe₂O₃9.0-MgO1.0 |
| Example 6 | Ag90.0-Fe₂O₃9.0-Al₂O₃1.0 |
| Example 7 | Ag90.0-Fe₂O₃9.0-In₂O₃1.0 |
| Example 8 | Ag90.0-Fe₂O₃9.0-La₂O₃1.0 |
| Example 9 | Ag90.0-Fe₂O₃9.0-CeO₂1.0 |
| Example 10 | Ag90.0-Fe₂O₃9.0-Sm₂O₃1.0 |
| Example 11 | Ag92.0-Fe₂O₃6.0-MgO2.0 |
| Example 12 | Ag92.0-Fe₂O₃7.5-MgO0.5 |
| Example 13 | Ag92.0-Fe₂O₃7.0-MgO1.0 |
| Example 14 | Ag92.0-Fe₂O₃5.5-MgO2.5 |

Electric contact materials of Examples 5 to 14 were produced also by powder metallurgy, as in First Embodiment. An Ag powder having an average particle size of 3 μm, an iron oxide powder having an average particle size of 2 μm, and a powder of magnesium oxide or the like included in each of the examples and having an average particle size of 2 μm were used as raw powders. The contact materials were produced using the same conditions and the procedure as in First Embodiment. Rivet contacts were produced from the electric contact materials of the respective examples and used in unsealed relays and sealed relays to be tested for endurance with the same conditions as First Embodiment. The relays for alternating current load to be tested, the endurance test conditions and others were all identical to those used in First Embodiment. The results of the endurance test in Second Embodiment are shown in Table 7.

TABLE 7

| | Conditions 1 | Conditions 2 | Conditions 3 | Conditions 4 |
|---|---|---|---|---|
| Example 5 | 34.2 | 0.4 | 50.8 | 80.2 |
| Example 6 | 27.1 | 10.0 | 45.1 | 70.5 |
| Example 7 | 32.7 | 7.4 | 51.6 | 81.5 |
| Example 8 | 33.8 | 6.2 | 52.5 | 82.3 |
| Example 9 | 29.4 | 15.2 | 40.3 | 90.8 |
| Example 10 | 35.2 | 6.3 | 55.2 | 92.5 |
| Example 11 | 35.7 | 4.6 | 57.2 | 90.6 |
| Example 12 | 33.5 | 8.6 | 53.2 | 85.5 |
| Example 13 | 30.1 | 12.4 | 55.5 | 89.4 |
| Example 14 | 32.3 | 10.6 | 57.6 | 91.3 |

(unit: ten thousand cycles)

Table 7 shows the average number of switching cycles provided by the relays in each of the examples (the average of numbers of switching cycles provided by 5 relays by the time they failed). The unsealed relays both under the conditions 3 and 4 have been found to have definitely higher endurances than the sealed relays both under the conditions 1 and 2. Further, the materials containing another oxide in addition to the iron oxide, as in Examples 5 to 14, have been found to provide higher endurance lives than those materials in Examples 1 to 4 of First Embodiment.

What is claimed is:

1. A sealed relay for alternating current load, which controls a resistance load comprising an alternating voltage of 80 V to 300 V and a rated current of 5 to 25 A by an Ag-based contact element disposed in a closed space,
wherein the Ag-based contact element comprises 4.0 to 20.0 wt. % of an iron oxide and Ag as the balance.

2. A method of increasing an endurance life of a sealed relay for alternating current load, which controls a resistance load comprising an alternating voltage of 80 V to 300 V and a rated current of 5 to 25 A,
wherein an Ag-based contact element comprising 4.0 to 20.0 wt. % of an iron oxide and Ag as the balance is disposed in a closed space to control said resistance load.

3. An Ag-based contact element material used in a sealed relay for alternating current load, which controls a resistance load comprising an alternating voltage of 80 V to 300 V and a rated current of 5 to 25 A by an Ag-based contact element disposed in a closed space,
wherein the Ag-based contact element material contains 4.0 to 20.0 wt. % of an iron oxide, 0.1 to 2.5 wt. % of oxides of one or more selected from the group consisting of magnesium, aluminum, indium, lanthanum, cerium and samarium, and Ag as the balance.

4. A sealed relay for alternating current load, which controls a resistance load comprising an alternating voltage of 80 V to 300 V and a rated current of 5 to 25 A by an Ag-based contact element disposed in a closed space,
wherein the Ag-based contact element comprises the Ag-based contact element material according to claim 3.

5. A method of increasing an endurance life of a sealed relay for alternating current load, which controls a resistance load comprising an alternating voltage of 80 V to 300 V and a rated current of 5 to 25 A,
wherein an Ag-based contact element comprising the Ag-based contact element material according to claim 3 is disposed in a closed space to control said resistance load.
